(19) United States
(12) Patent Application Publication
(10) Pub. No.: US 2011/0000341 A1
(43) Pub. Date: Jan. 6, 2011

(54) APPARATUS FOR REMOVING CHILDPROOF CAPS

(76) Inventor: Kenneth Taylor, Dayton, IN (US)

Correspondence Address: Buchanan Nipper LLC, P.O. Box 700, Perrysburg, OH, 43552-0700, US

(21) Appl. No.: 12/795,098

(22) Filed: Jun. 7, 2010

Related U.S. Application Data
(63) Continuation-in-part of application No. 12/197,344, filed on Aug. 25, 2008, now abandoned.
(60) Provisional application No. 60/957,921, filed on Aug. 24, 2007.

(51) Int. Cl. B67B 7/18

(52) U.S. Cl. 81/3.32

(57) ABSTRACT

An apparatus is provided for removing a childproof cap from a container having a locking mechanism. The apparatus comprises a cap engaging assembly wherein a first portion is urged toward a second portion that applies a force against the childproof cap when the container is maintained in a fixed position. The cap engaging assembly further comprises a actuating mechanism, such as a caming mechanism, that is configured such that as the first portion is urged toward the second portion, the cap is initially depressed in a linear direction until the actuating mechanism is engaged, whereby the second portion is rotated slightly relative to the first portion so that the childproof cap is also rotated and becomes disengaged from the locking mechanism of the container. The cap engaging assembly includes a locking mechanism that temporarily fixes the second portion in its rotated position, preventing the childproof cap from rotating back to its original position and facilitating removal of the childproof cap from the container.

### CROSS REFERENCE TO RELATED APPLICATIONS

This application is a continuation-in-part application of U.S. patent application Ser. No. 12/197,344, filed on Aug. 25, 2008 and currently pending, which claims priority to U.S. Provisional Application Ser. No. 60/957,921, filed on Aug. 24, 2007. Each of these related applications is hereby incorporated by reference into this disclosure in its entirety.

### FIELD

This invention relates to container-opening devices, more particularly to devices for removing locking twist caps from containers.

### BACKGROUND

Since their invention in the 1940s, specially configured caps for containers, such as medicine bottles, have been available to help prevent young children from accidentally ingesting the contents, while not posing an significant obstacle to being opened by those having greater manual dexterity. The most common type of childproof container is one where the cap must be depressed and turned at the same time in order for it to become disengaged from the container, an action that is difficult for very young children to perform spontaneously. Unfortunately, some individuals, particularly the elderly or those with physical challenges, can have difficulty in unlocking such a cap mechanism.

U.S. Pat. No. 6,393,947 (Corcoran et al.) describes an apparatus for removing childproof caps that provides a separate gripping means for depressing the cap and another for causing simultaneous rotation of the container, requiring two-handed operation. While such an apparatus may allow some individuals to remove caps more easily, it does not completely fulfill the need for others with more limited abilities. What is needed is a childproof cap removal apparatus that is reliable when employing single-handled operation such that it can be used by individuals of a variety of physical challenges.

### BRIEF SUMMARY

The invention provides for an apparatus for removing a childproof cap from a container having a locking mechanism that inhibits detachment of the childproof cap, the apparatus comprising a cap-engaging assembly comprising a first portion and a second portion configured to be urged toward the one another to apply a force against and rotation of the childproof cap when the container is maintained in a fixed position. The cap-engaging assemble further comprises a actuating mechanism, such as a caming mechanism and preferably, but not necessarily includes a compressible mechanism or means (e.g., a compression or torsion spring) disposed between the first portion and the second portion. The cap-engaging assembly and actuating mechanism are configured such that as the first portion is urged toward the second portion, the cap is contacted by the latter such that there is downward linear movement of the childproof cap relative to the container. Further compression of cap-engaging mechanism against the cap results in the actuating mechanism causing rotation of the second portion that engages the cap as linear pressure is maintained so that the childproof cap becomes disengaged from the locking mechanism such that it may be readily lifted from the container.

In another aspect of the invention, the cap-engaging mechanism is connected to an arm that is pivotably attached to support apparatus comprising an upright portion that is connected to a base support that receives the childproof container. As the lever is depressed by the user, the first portion of the cap-engaging assembly is urged downward toward the second portion while compressing a spring mechanism that interconnects the two until a follower element located underneath the first portion contacts the caming element located on the second portion, thereby causing a deflection therebetween that twists the section portion in a counter-clockwise direction relative to the first portion so that the cap is rotated in a direction that causes disengagement of the locking mechanism.

In still another aspect of the invention, the upright portion of the support apparatus is configured to attach to a wall or other vertical surface, such as by suction cups, screws, or another well-known affixation means. The cap-engaging mechanism may be operatively connected to the upright portion of the support apparatus using a compression or tension spring so that once it has been manually depressed to accomplish the disengagement of the childproof container locking mechanism, it may resiliently return to its original starting position.

In yet another aspect of the invention, the apparatus does not include a support apparatus. Rather, the first portion is configured so that pressure is applied directly to the top of the first portion or structure attached thereto so that a spring is depressed relative to the second portion while the container rests on a surface or special pad. As pressure is maintained, the caming mechanism, a torsional spring, or another type of actuating mechanism causes rotation of the second portion to disengage the cap from the container.

In still yet another aspect of the invention, the apparatus includes an electro-mechanical drive mechanism, such as a small electric motor connected to a threaded rod that is received by the cap-engaging mechanism. Rotation of the threaded rod by the motor causes the cap-engaging mechanism to be lowered and come into contact with the cap of the container located on the base support. As the actuating mechanism is activated, the second portion of the cap-engaging mechanism causes the disengagement of the childproof container's locking mechanism. Reversal of the motor allows the cap-engaging assembly to return to its original position and allow removal of the container.

Additional understanding of these exemplary embodiments can be obtained with review of the following detailed description and the appended drawings.

### BRIEF DESCRIPTION OF THE DRAWINGS

Embodiments of the present invention will now be described by way of example with reference to the accompanying drawings, in which:

FIGS. 1-2 depict perspective views of an illustrative embodiment of the present invention;

FIG. 3a-c depict side views of the caming mechanism of FIGS. 1-2;

FIG. 4 depicts a side view of a second embodiment of the present invention;

FIG. 5 depicts a side view a third embodiment of the present invention;

FIG. 6 depicts a side view of an alternative caming mechanism of the present invention.

FIG. 7 depicted a partially exploded view of an illustrative embodiment of the present invention comprising a motorized drive mechanism; and

FIG. 8 depicts an underside view of the cap-engaging mechanism of FIG. 7.

FIG. 9 is a perspective view of an alternative cap engaging assembly. The assembly is illustrated in a first configuration.

FIG. 10 is a top view of the first portion of the cap engaging assembly illustrated in FIG. 9.

FIG. 11 is a perspective view of the cap engaging assembly illustrated in FIG. 9. The assembly is illustrated in a second configuration.

### DETAILED DESCRIPTION

For the purposes of promoting an understanding of the principles of the invention, reference will now be made to the embodiments illustrated in the drawings, and specific language will be used to describe the same. It should nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. Any other undisclosed or incidental details of the construction or composition of the various elements of the disclosed embodiment of the present invention are not believed to be critical to the achievement of the advantages of the present invention, so long as the elements possess the attributes needed for them to perform as disclosed. The selection of these and other details of construction are believed to be well within the ability of one of even rudimentary skills in this area, in view of the present disclosure. The invention encompasses embodiments both comprising and consisting of the elements described with reference to the illustrative embodiments. Unless otherwise indicated, all ordinary words and terms used herein shall take their customary meaning as defined in The New Shorter Oxford English Dictionary, 1993 edition.

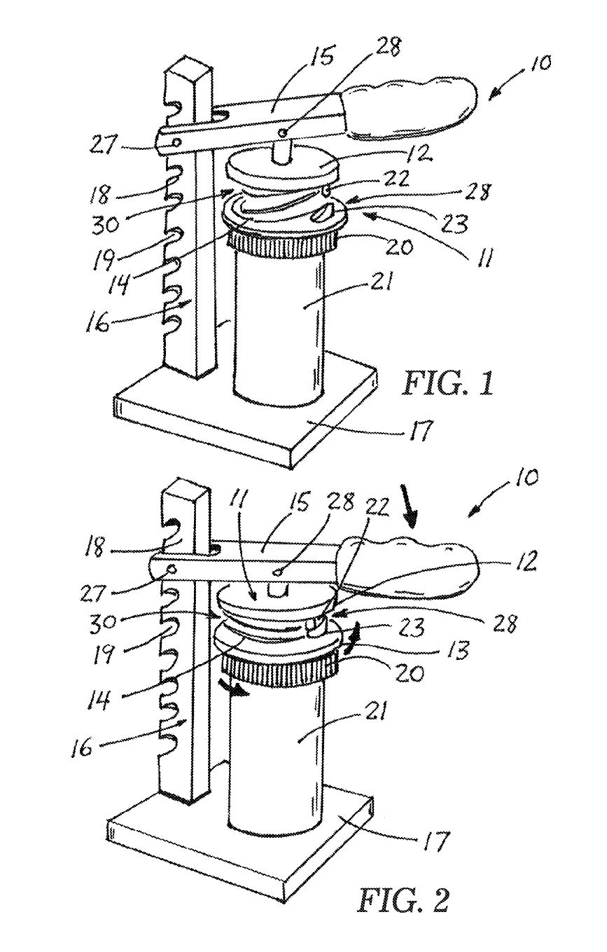

The present invention, as embodied in FIGS. 1-8 comprises a apparatus 10 for removing a childproof cap 20 from a container 21, such as a medicine bottle, the apparatus comprising a cap-engaging assembly 11 that includes a first portion 12 and a second portion 13 that include complimentary elements of an actuating mechanism 30 that it configured such as the first portion is manually depressed or urged relative to the second portion. As such, the second portion is caused to rotate, typically in a counter-clockwise direction after the actuating mechanism 30 becomes engaged. When the second portion 13, which preferably comprises a textured or other type of bottom surface adapted for gripping, is urged against a childproof cap 20 that is lockingly engaged to a container 21 resting on or against a surface, this two-part action of initially causing a downward force against the childproof cap 20, followed by rotational movement of the cap that shifts the locking tabs of the cap under and past the locking structure located along the outer top rim of the container (locking mechanism not shown). This allows the cap to become disengaged from the locking mechanism and container such that once the second portion 13 and the childproof cap are separated from one another, the cap can be readily lifted off of the container without further manipulation required. If the container 21 is prevented from rotational movement by frictional engagement between the bottom of the container and a slip-free surface, such as a appropriately configured base member 17, pad, 24, or secured by another means, the operation can be performed using only one hand, or only by applying force against the first portion 12 of the actuating mechanism 30 or structure connected thereto.

FIGS. 1-2 depict an exemplary embodiment of the present invention in which the first portion 12 of the cap-engaging assembly 11 is operatively connected to an arm 15 that in turn, is connected to a support structure 16 comprising an upright member 18 that is attached to a base support 17 configured for receiving and holding the container, the connection of the arm to the upright member comprising an interconnecting pivot mechanism 27, such as a pin or projections that are received within a hole and/or pair of recesses. The upright member includes a series of slots 19 that allow the height of the arm 15 and pivot mechanism 27 to be adjusted relative to the base support 17 to accommodate different sizes (heights) of containers 21. One skilled in the mechanical arms would recognize that other mechanisms for adjusting the location of the pivot mechanism 27, such as spring action pegs, etc., may be used.

The cap-engaging assembly 11 comprises the first portion 12, which is attached to the exemplary arm 15, such as by the illustrative pivoting connection 28 that helps maintain the first portion 12 at an optimal angle relative to the top of the childproof cap 20. The first portion 12 is interconnected to the second portion 13 of the cap-engaging assembly 11 by a compressible mechanism 14, such as the illustrative compression spring that allows the first portion 12 to be depressed downward to transfer force against the second portion 13 and the childproof cap 20 engaged therewith, releasing the force against the second portion 13 and cap 20 when the spring mechanism 14 is allowed to return to the original relaxed configuration. In addition to a single compression spring 14, a plurality of springs may be used or another compressive mechanism that allows the first portion 12 and second portion 13 to be resiliently moved into closer proximity to one another.

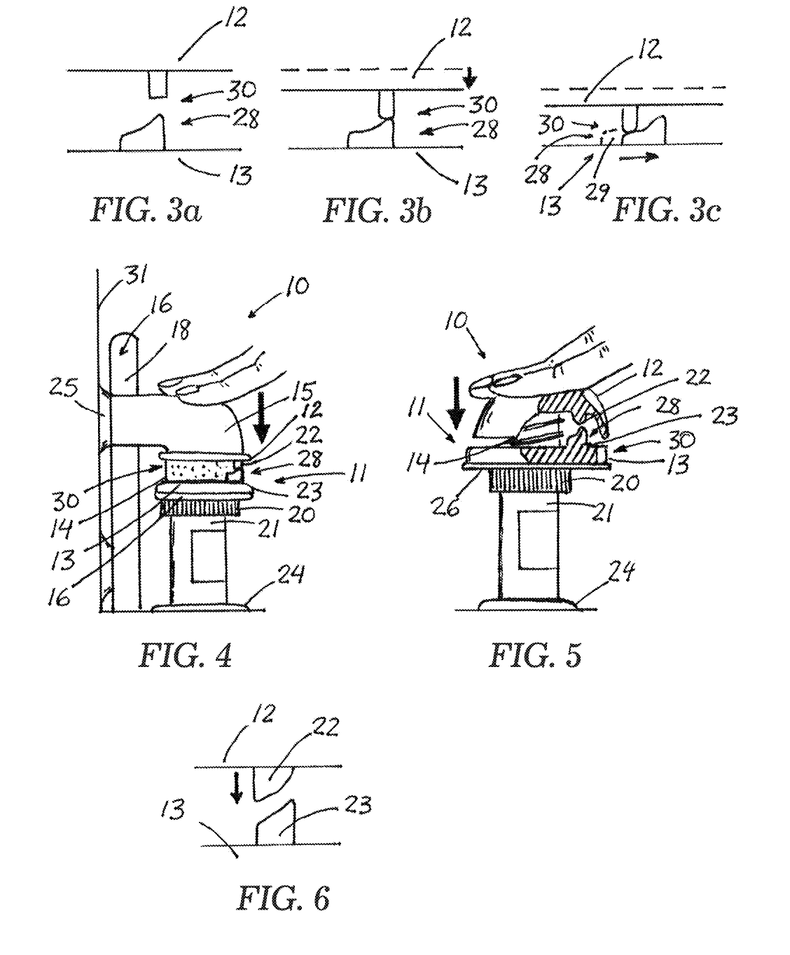

Another desired property of the compressive mechanism or element 14 is having it be able to undergo sufficient torsional or rotational movement such that the second portion 13 can be rotated at least a few degrees by the action of force being applied to the first portion 12. The illustrative compression spring 14 provides for the necessary two-part action of linear compression to supply the force that urges the tabs of the childproof cap downward to separate them from the locking structure along the container, then allowing for rotational movement of the second portion 13 relative to the first portion 12 such that the locking tabs are shifted to a portion, whereby when the downward force is removed, the tabs are aligned with slots located between the locking structure so that the cap can be lifted off of the container with relative ease. The second part of the two-part action, the rotational movement of the second portion 13 that completes the disengagement between the childproof cap and container (FIG. 2), is supplied by a caming mechanism 28 or other means in which linear force applied to the first portion 12, such as with the illustrative arm 15 or handle being pressed downward thereagainst, causing contact between a follower element 22 disposed on the underside of the first portion 12 and a caming element 23 disposed on the upper face of the second portion 23, best depicted in sequence of FIG. 3a-b. As the application of downward force continues, the follower 22 is deflected along a curvilinear surface of the caming element 23, which causes the second portion 13 to rotate for a distance 29 relative to the first portion 12 approximately equal to the distance the follower element 22 travels along the caming element 23, a distance that is sufficient to shift the locking tabs of the cap to align them with the open slots along the container 21. As an alternative to the illustrative caming mechanism, the follower element could be located on the second portion 13 instead of the first portion 12, or as depicted in FIG. 6, the two elements 22,23 of the caming mechanism 28 could be similar in configuration. In fact, one skilled in the mechanical arts would appreciate that a variety of caming mechanism could be selected or conceived that would allow for the second portion 13 to urge the childproof cap 20 downward relative to the container 20, followed by a caming action that rotationally realigns the childproof cap so that it can be removed therefrom. In addition to a caming mechanism 28 comprising a follower element 22 and caming element 23, as depicted, a torsion spring may be used that is wound such that is causes rotational movement when compressed. Since rotational movement of the second portion 13 and childproof cap 20 alone by design cannot cause the cap to disengage from the container 21, the compressible mechanism 14 comprising the torsion spring should be configured to allow an initial linear compression between the first and second portions 12,13 to separate the locking mechanism between cap and container. This feature could be designed into the spring itself, or the torsional spring could be used in combination with a compression spring or other compressible means which interconnects the first and second portion 12,13 and allows for linear compression, whereby the torsion spring is unconnected to the first portion and separated by a small gap therefrom such that there is a desired amount of linear compression before contact between the torsion spring and first portion causes the rotational movement of the second portion and childproof cap to commence. It should be noted that the first portion 12 could comprises two interconnected portions that rotate relative to one another such that at least a portion of actuating mechanism 30, such as that which is attached to the upper part of the compressible mechanism/spring, is attached to two portions of the apparatus 10 that rotate together while the grippable portion of the first portion remains stationary. Nevertheless, the actuating mechanism 30 should be still be interpreted as interconnecting the first and second portions 13 and cause rotational movement relative thereto in this particular instance.

While the embodiment of FIGS. 1-2 includes a cap-engagement mechanism connected to free-standing support apparatus 16, other configuration are contemplated, such as the apparatus of FIG. 4 in which the upright portion 18 of the support 16 is secured against an vertical surface 31, such as a wall by means of the illustrative suction cups 25 for ease of repositioning, or using a more permanent attachment such as screws or other anchoring means. In the illustrative embodiment, the base portion is eliminated in favor of an optional pad 25 placed on the horizontal surface which includes a tacky, textured, or other optimized surface for gripping the bottom of the container, thereby reducing or eliminating the need for manually gripping the container to prevent its rotation. Other features of the present embodiment include a non-pivoting arm 15 that is manually urged straight downward to cause the cap-engaging mechanism 30 to contact the childproof cap 20. An appropriately configured tension spring attached above the arm 15, or a compression spring attached below the arm (neither shown) would allow the arm to return to a initial portion in which the second portion 13 does not contact the top of the childproof cap 20, when the latter is positioned therebelow. Also depicted, the compressible mechanism 14 comprises a plurality of resiliently compressible foam columns that allow for both linear compression and sufficient twisting to accommodate the necessary rotational movement of the second portion 13 relative to the first portion 12 to which they are attached.

FIG. 5 depicts and embodiment that does not include a support apparatus 16 or arm 15 to supply the downward force to activate the actuating mechanism 30. Rather, the actuating mechanism comprising the interconnected first and second portions 12,13 is positioned over and against the top of the childproof cap and container 20,21 (preferably with a pad 24 or appropriate surface underneath) and force is applied manually directly to the first portion, with the resulting action working much like that depicted in FIGS. 1-2. It should be noted that the illustrative embodiment could be configured such that the first or the section portions 12,13 are both configured to be held by the user, as well as being able to engage a surface of the cap and container to cause disengagement of the locking mechanism. For example, the second portion 13 could be maintained stationary by the user while the bottom of the container is set on the upper surface of the first portion 12 and the top of the cap urged against a horizontal surface, such as the underside of a cabinet. If such an apparatus was inverted, the cap and container would be inverted as well for disengagement to be possible. By eliminating the arm and support 15, the embodiment of FIG. 5 has the advantage of being perhaps more portable and versatile than the embodiments of FIGS. 1-2, and 4.

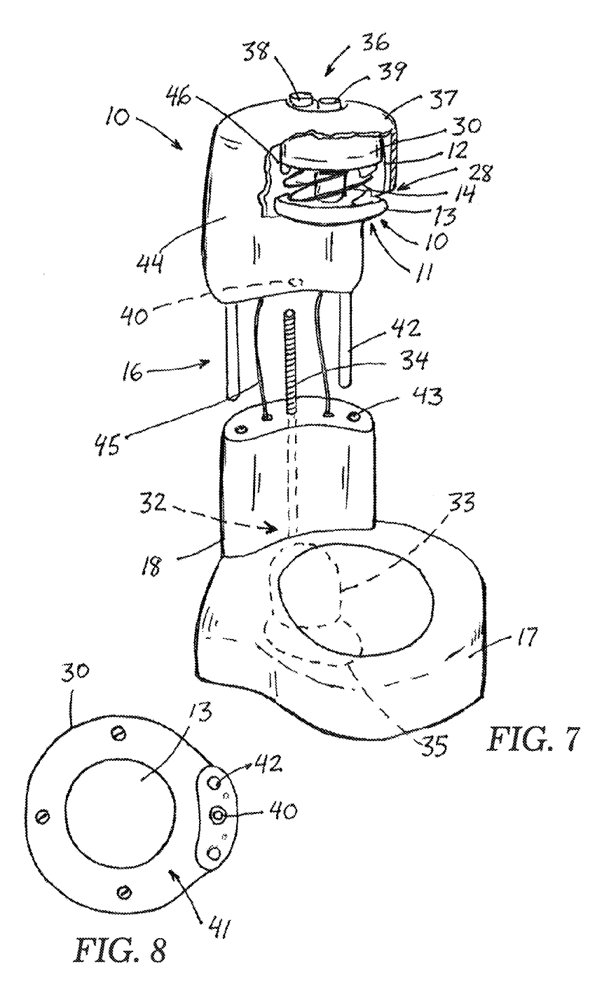

To eliminate the need for a physically challenged individual having to manually depress the first portion of the apparatus to urge it toward the second portion to contact and loosen the cap, the present invention may be configured to include a drive mechanism 32 comprising a small electric motor 33 or other electro-mechanical means to fulfill that function, as depicted in the embodiment of FIG. 7. In the illustrative embodiment, the drive mechanism 32 includes a standard electric motor 33, disposed within the base support 17 of the support structure 16, that drives a threaded rod 34 connected thereto by a series of gears that permit the threaded rod to be rotated at the appropriate speed. Power to the motor is supplied by a battery pack 35 or other DC power source that is situated within the lower housing or alternatively, partially or completely external thereto. Alternatively, the apparatus could be configured to operate using AC current or less-traditional energy sources, although the power needs of this embodiment would be minimal. In the illustrative embodiment, a switching mechanism 36 is located on the top surface of the outer housing 37 of the actuating mechanism 30 comprising the cap-engaging assembly 11. The switching mechanism 36 includes a first switch 38 that is depressed or otherwise actuated to rotate the threaded rod 34, which is received by a threaded nut 40 affixed to and located on the underside 41 of the outer housing 37 (FIG. 8), thus causing the cap-engaging assembly 11 to be urged downward toward the base support 17 with rotation of the threaded rod 34. The upright member 18 of the support structure 16 is configured to slidably receive the actuating mechanism 30 comprising the cap-engaging assembly 11 via two posts 42 that extend downward from the lower portion 44 of the outer housing 37 and are slidably received into two channels 43 located about the upright member 18. Adjacent channels may dedicated for wires 45 extending from the switches and/or sensors 46 that lead to the battery pack 35 or power supply. As the rod 34 continued to rotate, the lower portion 44 of the outer housing 37 of the actuating mechanism 30 slides downward over the upright member 18 extending from the base support as the spring (compressible element 14) is compressed, allowing the first and second portions 12,13 of the cap-engaging assembly 11 to come into contact with one another via the caming mechanism 28 such that the cap-removal process can be accomplished as similar to that described for the previous embodiments. After the container 21 with the loosened cap 20 is removed from the base support 17, a second switch 39 of the switch assembly 36 may be activated to cause the rod 34 to reverse its original direction of rotation so that the cap-engaging assembly is urged upward and the apparatus 10 is available to receive another container. Alternatively, the drive apparatus 32 could be configured such that once the second portion 13 of the actuating mechanism 30 has rotated and loosened the cap 21, a sensor 46 senses the rotation of the second portion and signals the motor 33 of the drive mechanism 32 to reverse its direction automatically so that the actuating mechanism 30 is returned to its original starting position upon completion of the operation. One skilled in the mechanical arts would appreciate that the illustrative drive mechanism 32 is merely exemplary and that there are other known mechanical or electro-mechanical systems that could be adapted or configured to raise or lower the actuating mechanism 30 of the present invention or cause the first and second portions 12,13 to move into approximation to one another to reduce or eliminate the need for manual force supplied by the user.

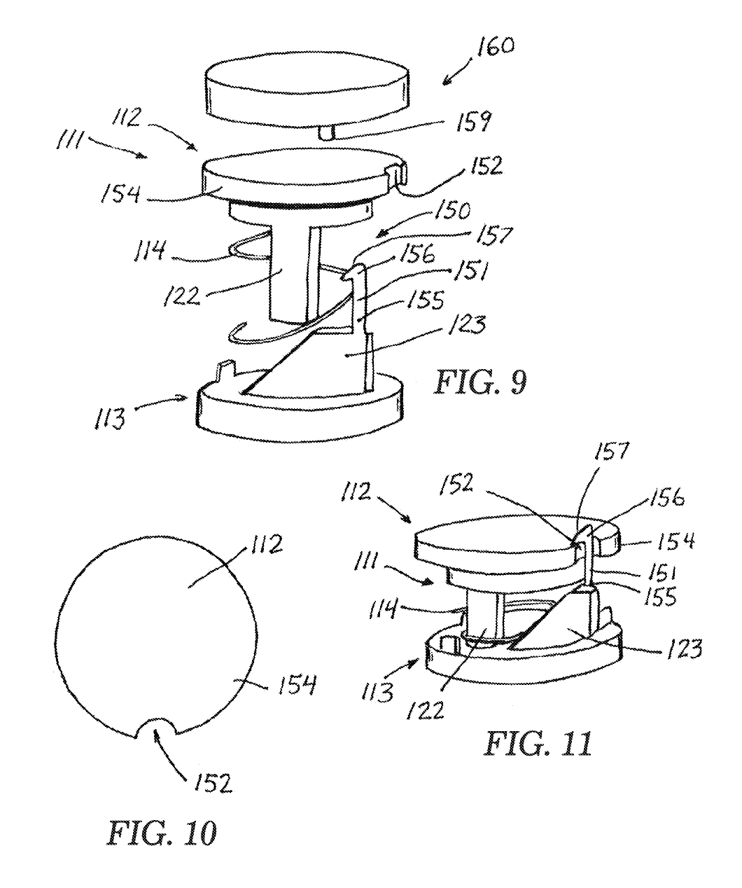

FIGS. 9 through 11 illustrate an alternative cap engaging assembly 111 that can be used in an apparatus according to the disclosure, including the exemplary apparatuses described and illustrated herein. Similar to the embodiments described above, the cap engaging assembly 111 includes a first portion 112 and a second portion 113. The first portion 112 is interconnected to the second portion 113 of the cap engaging assembly 111 by a compressive mechanism 114, such as the illustrative compression spring that allows the first portion 112 to be depressed downward to transfer force against the second portion 113, which, in turn, can engage and remove a childproof cap, as described above.

Also in a manner similar to the embodiments described above, continued movement of the first portion 112 toward the second portion 113 causes a follower element 122 disposed on the underside of the first portion 112 to contact a caming element 123 disposed on the upper face of the second portion 113. Once this contact has occurred, continued movement of the first portion 112 toward the second portion 113 causes rotational movement of the second portion 113. If the first portion 112 is held in a fixed postion, such as if the first portion 112 is contained within a housing, the second portion 113 will rotate without causing the first portion 112 to rotate. Similarly, if a container having a childproof cap this is engaged by the second portion 113 is held in a fixed postion, such as by being gripped by a stand, housing, or other suitable apparatus, the cap will rotate along with the second portion 113 while the container stays in the fixed portion, eventually allowing for removal of the cap from the container.

The stress placed on the compressive mechanism 114 may produce a tendency for the second portion 113 to rotate back to its original position, which may hinder or prevent removal of the childproof cap from the container.

To prevent this tendency of the second portion 113 to rotate back to its original position, the cap engaging mechanism 111 of this embodiment includes a locking mechanism 150 that temporarily fixes the second portion 113 in its rotated position relative the first portion 112 and the starting position of the second portion 113, i.e., before initiation of rotation of the second portion 113 by contact between the follower element 122 and the caming element 123.

The locking mechanism 150 includes a post 151 and a channel 152 configured to receive the post 151. The post 151 extends from an upper surface of the caming element 123, away from the upper face of the second portion 113 and toward the underside of the first portion 112. The channel 152 extends through the thickness of the first portion 112. As best illustrated in FIG. 10, the channel 152 advantageously opens to a peripheral edge 154 of the first portion 112 of the cap engaging assembly 111. It is noted, though, that alternative channel structures can be used, including channels that are entirely defined by an inner edge and/or surface of the first portion 112. Also, the channel 152 can extend only partially into the thickness of the first portion 112. Thus, the channel extends at least partially into the thickness of the first portion 112. Any combination of these structural features of the channel can be used in an apparatus according to a particular embodiment.

The post 151 has a first end 155 that is advantageously continuous and integrally formed with the caming element 123, and a second end 156 that defines a protrusion 157. The protrusion 157 has a width, defined as a an edge-to edge dimension of the post on a plane that is orthogonally oriented with a longitudinal axis of the post 151, that is greater than a width of the post 151 at a position along its length that does not include the protrusion 157. As described above, the protrusion 157 cooperates with the channel 152 to accomplish the desired temporary locking of the second portion 113 in its rotated position.

FIG. 9 illustrates the cap engaging assembly 111 in a first configuration 160, in which the first portion 112 has not been axially advanced toward the second portion 113 to a point that achieves contact between the follower element 122 and the caming element 123. As such, rotation of the second portion 113 has not yet been initiated. In this configuration, the post 151 extends away from the upper face of the second portion 113 and toward the underside of the first portion 112, but does not extend into or through the channel 152.

FIG. 10 illustrates the cap engaging assembly 111 in a second configuration 170, in which the first portion 112 has been axially advanced toward the second portion 113 such that contact between the follower element 122 and the caming element 123 has been initiated. Indeed, the first portion 112 has been axially advanced toward the second portion 113 such that the continued contact between the follower element 122 and the caming element 123 has forced the follower element 122 to move down the angled surface of the caming element 123, effectuating rotational movement of the second portion 113 relative to the first portion 112 and the starting postion of the second portion 113 in the first configuration.

In the second configuration 170, the post 151 extends through the channel 152 such that the protrusion 157 rests on top of the upper face of the first portion 112. In this locked configuration 170, the post 151, by way of the contact between the protrusion 157 and the upper face of the first portion 112, resists the tendency of the second portion 113 to rotate back to its original position. In effect, the post 151, in this configuration, resists the stress stored in the compression mechanism 114 during the rotation of the second portion 113.

In the second configuration 170, the first 112 and second 113 portions of the cap engaging assembly 111 are locked in position relative to each other, both rotationally and axially. Thus, while in this configuration, the cap engaging assembly 111 can be lifted from the container, allowing a user to removed the childproof cap that has been disengaged from the container by operation of the assembly.

To restore the cap engaging assembly 111 to the first configuration, which will allow a user to operate the assembly on another container and childproof cap, a protrusion or other suitable mechanical member, such as tooth 159, can be moved to contact the protrusion 157 to disrupt the contact between the protrusion 157 and the upper face of the first portion 112. Once a suitable disruption has occurred, the protrusion 157 moves into the channel 152, and the stress stored in the compression mechanism 114 returns the cap engaging assembly 111 to the first configuration.

The embodiments described and illustrated herein provide examples of the invention, and are not intended to limit the scope of the invention in any manner. Rather, they serve only to aid those skilled in the art to make and use the invention.

I claim:

1. An apparatus for removing a childproof cap from a container having a locking mechanism inhibiting detachment of said childproof cap, said apparatus comprising:
a cap engaging assembly comprising a first portion, a second portion, and a compressive mechanism disposed between and connecting the first portion and the second portion, the first portion having a first portion upper face and a first portion underside and the second portion having a second portion underside and a second portion upper face disposed opposite the first portion underside;
a caming element disposed on the second portion upper face and extending toward the first portion underside;
a follower element disposed on the first portion underside and extending toward the second portion upper face;
a post disposed on the caming element and extending toward the first portion, the post having a first end contacting the caming element and a second, opposite end defining a protrusion; and
a channel defined by the first portion, the channel sized to allow the protrusion of the post to pass through the channel;
the cap engaging assembly having a first configuration in which the second portion has a first rotation position relative to the first portion and the protrusion is not in contact with the first portion upper face, and a second configuration in which the second portion has a second rotation position relative to the first portion and the first rotation position of the second portion and the protrusion is in contact with the first portion upper face;
wherein the cap engaging assembly is movable between the first and second configurations by advancing the first portion toward the second portion such that the follower element contacts the caming element.

2. The apparatus of claim 1, wherein the cap-engaging assembly is connected to a movable arm connected to a support apparatus.

3. The apparatus of claim 1, wherein the compressive mechanism comprises a spring.

4. The apparatus of claim 1, wherein the compressive mechanism comprises a compressible foam.

5. The apparatus of claim 1, wherein the first potion has a thickness extending from the first portion upper face to the first portion underside and the channel extends at least partially into the thickness.

6. The apparatus of claim 1, wherein the first potion has a thickness extending from the first portion upper face to the first portion underside and the channel extends through the thickness.

7. The apparatus of claim 1, wherein the first portion has a peripheral edge and the channel opens to the peripheral edge.

8. The apparatus of claim 1, wherein the first portion has an inner edge the entirely defines the channel.

9. The apparatus of claim 1, further comprising a drive mechanism operably connected to the cap engaging assembly and adapted to advance the cap engaging assembly in a direction toward said childproof cap and said container.

10. The apparatus of claim 9, wherein the drive mechanism comprises an electric motor.

11. The apparatus of claim 10, wherein the drive mechanism further comprises a threaded rod connected to the electric motor which is disposed within a support apparatus, wherein the threaded rod is operatively connected to the cap-engaging assembly such that rotation of the threaded rod causes the cap-engagement assembly to move relative to the support apparatus to which it is slidably engaged.

12. An apparatus for removing a childproof cap from a container having a locking mechanism inhibiting detachment of said childproof cap, said apparatus comprising:
a cap engaging assembly comprising a first portion, a second portion, and a compressive mechanism disposed between and connecting the first portion and the second portion, the first portion having a first portion upper face, a first portion underside, and a thickness extending from the first portion upper face to the first portion underside, and the second portion having a second portion underside and a second portion upper face disposed opposite the first portion underside;
a caming element disposed on the second portion upper face and extending toward the first portion underside;
a follower element disposed on the first portion underside and extending toward the second portion upper face;
a post disposed on the caming element and extending toward the first portion, the post having a first end contacting the caming element and a second, opposite end defining a protrusion; and
a channel defined by the first portion, the channel extending at least partially into the thickness of the first portion and sized to allow the protrusion of the post to pass into the channel;
the cap engaging assembly having a first configuration in which the second portion has a first rotation position relative to the first portion and the protrusion is not in contact with the first portion upper face, and a second configuration in which the second portion has a second rotation position relative to the first portion and the first rotation position of the second portion and the protrusion is in contact with the first portion upper face;
wherein the cap engaging assembly is movable between the first and second configurations by advancing the first portion toward the second portion such that the follower element contacts the caming element.

13. The apparatus of claim 12, wherein the cap-engaging assembly is connected to a movable arm connected to a support apparatus.

14. The apparatus of claim 12, wherein the compressive mechanism comprises a spring.

15. The apparatus of claim 12, wherein the compressive mechanism comprises a compressible foam.

16. The apparatus of claim 12, wherein the first portion has a peripheral edge and the channel opens to the peripheral edge.

17. The apparatus of claim 12, wherein the first portion has an inner edge the entirely defines the channel.

18. An apparatus for removing a childproof cap from a container having a locking mechanism inhibiting detachment of said childproof cap, said apparatus comprising:
a cap engaging assembly comprising a first portion, a second portion, and a compressive mechanism disposed between and connecting the first portion and the second portion, the first portion having a first portion upper face, a first portion underside, a thickness extending from the first portion upper face to the first portion underside, a peripheral edge and an inner edge, and the second portion having a second portion underside and a second portion upper face disposed opposite the first portion underside;
a caming element disposed on the second portion upper face and extending toward the first portion underside;
a follower element disposed on the first portion underside and extending toward the second portion upper face;
a post disposed on the caming element and extending toward the first portion, the post having a first end contacting the caming element and a second, opposite end defining a protrusion; and
a channel defined by the inner edge of the first portion and extending through the thickness of the first portion, the channel sized to allow the protrusion of the post to pass into the channel;
the cap engaging assembly having a first configuration in which the second portion has a first rotation position relative to the first portion and the protrusion is not in contact with the first portion upper face, and a second configuration in which the second portion has a second rotation position relative to the first portion and the first rotation position of the second portion and the protrusion is in contact with the first portion upper face;
wherein the cap engaging assembly is movable between the first and second configurations by advancing the first portion toward the second portion such that the follower element contacts the caming element.

19. The apparatus of claim 18, wherein the compressive mechanism comprises a spring.

20. The apparatus of claim 18, wherein the compressive mechanism comprises a compressible foam.
